(19) United States
(12) Patent Application Publication
(10) Pub. No.: US 2011/0113329 A1
(43) Pub. Date: May 12, 2011

(54) MULTI-TOUCH SENSING DEVICE FOR USE WITH RADIOLOGICAL WORKSTATIONS AND ASSOCIATED METHODS OF USE

(76) Inventor: Michael Pusateri, Las Vegas, NV (US)

(21) Appl. No.: 12/941,740

(22) Filed: Nov. 8, 2010

Related U.S. Application Data
(60) Provisional application No. 61/259,604, filed on Nov. 9, 2009.

(51) Int. Cl. G06F 3/041

(52) U.S. Cl. 715/702; 345/173

(57) ABSTRACT

Multi-touch sensing device for use with radiological workstations and methods of use. The multi-touch sensing device may be capable of displaying radiological images, the device having a touch screen communicatively coupled with the radiological workstation via a controller, the touch screen adapted to display a work area that includes at least one of a first sensing area adapted to receive touch gestures from a first hand of a user and a second sensing area adapted to receive touch gestures from a second hand of the user.

### CROSS-REFERENCE TO RELATED APPLICATION

This application is related to and claims the priority benefit of U.S. provisional patent application No. 61/259,604, filed Nov. 9, 2009 and titled A multi-touch sensing device and associated gestures, graphical user interface software system and method(s) that is overlayed, interfaced or integrated to a commercially available PACS (Picture Archiving System(s)), RIS (Radiology Information System(s)) and/or LIS (Laboratory Information System(s)). The disclosure of the aforementioned application is incorporated herein by reference.

### FIELD OF THE INVENTION

The present invention relates generally to healthcare, and more specifically, but not by way of limitation, to the radiological field and radiological workstations.

### SUMMARY OF THE INVENTION

The present invention relates generally to multi-touch sensing devices, and more specifically, but not by way of limitation, to multi-touch sensing devices for use with one or more components of a picture archiving system such as a radiological workstation, the multi-touch sensing devices adapted to allow users to efficiently analyze radiological images and efficaciously create radiological reports. According to some embodiments, the present invention may be directed to a multi-touch sensing device for use with a radiological workstation capable of displaying radiological images, the device including (a) a touch screen that can be communicatively coupled with the radiological workstation via a controller, the touch screen adapted to display a work area that includes at least one of: (1) a first sensing area adapted to receive touch gestures from a first hand of a user; and (2) a second sensing area adapted to receive touch gestures from a second hand of the user; and (b) wherein touch gestures received from the user via the touch screen execute functions controlling a medical imaging application executable on the radiological workstation, the medical imaging application adapted to allow a user to analyze radiological images.

According to additional embodiments, the present invention may be directed to radiological workstations capable of displaying radiological images. The radiological workstation may include (a) a memory for storing at least one of a device driver application and a medical imaging application; (b) a processor for executing at least one of the device driver application and the medical imaging application; (c) a controller communicatively coupling the radiological workstation with the multi-touch sensing device; and (d) a multi-touch sensing device that includes: (1) a touch screen communicatively coupled with the radiological workstation, the touch screen adapted to display a work area that includes at least one of (i) first sensing area adapted to receive touch gestures from a first hand of a user; and (ii) a second sensing area adapted to receive touch gestures from a second hand of the user; and (2) wherein touch gestures received from the user via the touch screen execute functions controlling the medical imaging application via one or more application programming interfaces, the medical imaging application adapted to allow a user to analyze radiological images and create a radiological report indicative of the radiological images.

According to the present disclosure, one or more methods for controlling a medical imaging application executable on a radiological workstation are provided herein. The medical imaging application may include functions that allow a user to analyze radiological images or create radiological reports. The methods may include the steps of: (a) receiving a request to display at least one radiological image, the request including touch gestures received from a multi-touch sensing device, the multi-touch sensing device including: (1) a touch screen that is communicatively coupled with the radiological workstation via a controller, the touch screen adapted to display a work area that includes at least one of: (i) a first sensing area adapted to receive touch gestures from a first hand of a user; and (ii) a second sensing area adapted to receive touch gestures from a second hand of the user; and (2) wherein touch gestures received from the user via the touch screen execute functions controlling the medical imaging application via one or more application programming interfaces, the medical imaging application adapted to allow a user to analyze radiological images and create a radiological report indicative of the radiological images; and (b) displaying at least one radiological image via a radiological workstation in response to a received touch gesture.

### BRIEF DESCRIPTION OF THE DRAWINGS

FIG. 1 is a block diagram of an exemplary architecture for practicing various embodiments of the invention.

FIG. 2 is a perspective view of a multi-touch sensing device and two high-resolution monitors displaying radiological images.

FIG. 3 is a block diagram of a controller having a device driver application for communicatively coupling a multi-touch sensing device with a radiological workstation.

FIG. 4A is an exemplary user interface in the form of a work area displayed on the multi-touch sensing device.

FIG. 4B is an alternate view of the exemplary user interface of FIG. 4A showing a work list overlaid upon a portion of the work area.

FIG. 5 is a flow diagram of a method for displaying at least one radiological image utilizing a multi-touch sensing device.

FIG. 6 is a block diagram of an exemplary system for selecting and providing targeted prospects in accordance with various embodiments of the present invention.

### DETAILED DESCRIPTION OF THE INVENTION

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated.

Multi-touch sensing devices for use with radiological imaging workstations and associated methods of use are provided herein. Generally speaking, radiological images may be obtained from many different image capturing devices such as ultrasound, magnetic imaging, computer tomography, endoscopic, positron emission tomography, etc. A radiologist may analyze the images obtained by the image capturing devices to create a radiological report that may be utilized in the formation of a diagnosis for a patient. It will be understood that the radiological report created by the radiologist may be archived for later retrieval or communicated directly to the patient's physician.

Radiological images may be obtained, communicated, and stored utilizing a picture archiving and communication system (PACS) that operates according to a digital image and communications in medicine (DICOM) standard. It will be understood that a picture archiving and communication system may generally include image capturing devices, radiological workstations, physician workstations, remote archiving servers, and the like.

A radiologist may utilize a radiological workstation to prepare a radiological report corresponding to one or more radiological images obtained from a particular patient via an image capturing device. In some embodiments, the radiological workstation may include a particular purpose computing system being programmed with a medical imaging application adapted to transform one or more radiological images into a radiological report.

The radiological workstation may be communicatively coupled with one or more high-resolution display devices. Additionally, the workstation may include a plurality of input devices such as a mouse, trackball, keyboard, microphone, and the like. The radiologist may utilize the input devices to control the functions of the medical imaging application allowing the radiologist to view, modify, or otherwise manipulate radiological images. Additionally, the radiological workstation may include additional ancillary applications or devices that allow the radiologist to include additional pertinent diagnostic information within the radiological report.

Unfortunately, input devices such as mice and keyboards are limited in both the amount and variety of input types they are adapted to receive. For example, a mouse may be adapted to receive input from clicking buttons or scrolling input from a roller ball. While a mouse may be adapted to recognize a very limited number of touch gestures (e.g., click and drag) from the user, a keyboard is unable to recognize touch gestures.

It will be understood that the analysis of radiological images can be both time consuming and input intensive due to the fact that radiological images may need to be thoroughly scrutinized and viewed from multiple points of view and/or annotated with appropriate commentary. Moreover, many radiological imaging studies contain a plurality of radiological images that may all need to be evaluated independently or collectively. Also, with regards to certain three dimensional imaging studies (e.g., magnetic resonance imaging) the radiologist may be required to navigate spatially through three dimensional radiological images. The aforementioned radiological analyses require extensive utilization of input devices. As such, the risk to a radiologist of developing carpal and/or cubital tunnel syndrome is elevated.

Therefore, a multi-touch sensing device may be provided to more efficiently analyze radiological images and efficaciously create radiological reports corresponding to the radiological images while avoiding the deleterious effects caused by excessive use of commonly utilized input devices.

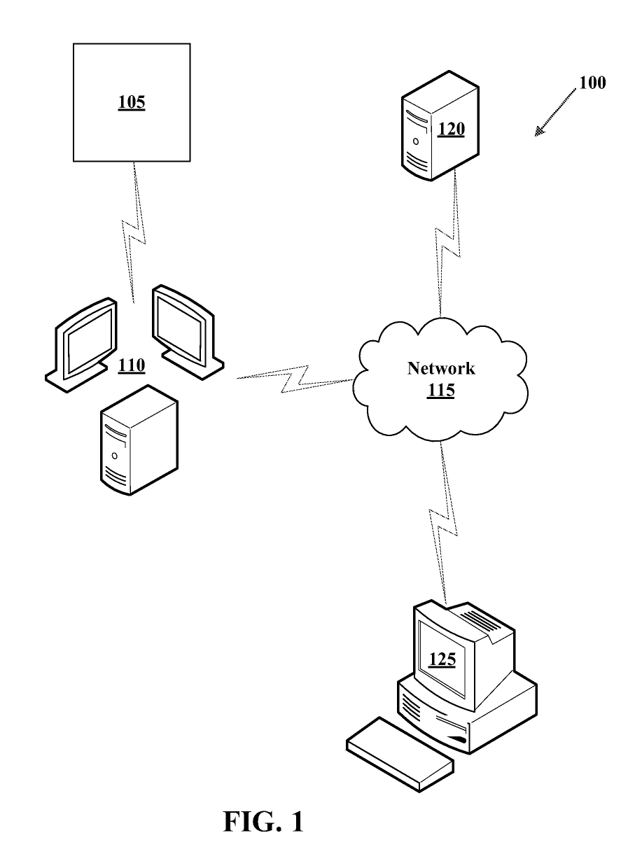

Referring now to the drawings, and more particularly to FIG. 1, a block diagram of an exemplary architecture 100 for practicing various embodiments of the invention is shown. It will be understood that in some embodiments, the architecture 100 resembles all or a portion of a picture archiving system (PACS). Generally speaking, the architecture 100 may include one or more image capturing devices 105 communicatively coupled with one or more radiological workstations 110.

The one or more workstations 110 may be communicatively coupled with a remote archiving server 120 via network 115 that may include the Internet, an Intranet network such as a LAN (Local Area Network) or WAN (Wide Area Network), a VPN (Virtual Private Network), etc.

A plurality of physician workstations 125 may likewise access the remote archiving server 120 via network 115. It will be understood that in some embodiments the radiological workstations 110 and the physician workstations 125 may be communicatively coupled with one another directly through the network 115 facilitating a bi-directional path of communication for exchanging radiological images, studies, and/or reports. Additionally, a peer-to-peer communications link may be established between a radiological workstation 110 and a physician workstation 125 for collaborative analysis of radiological images, as will be discussed in greater detail infra.

It will be understood that one or more of the components of architecture 100 may operate according to the digital image and communications in medicine (DICOM) standard that governs the methods with which radiological images may be obtained, communicated, and stored.

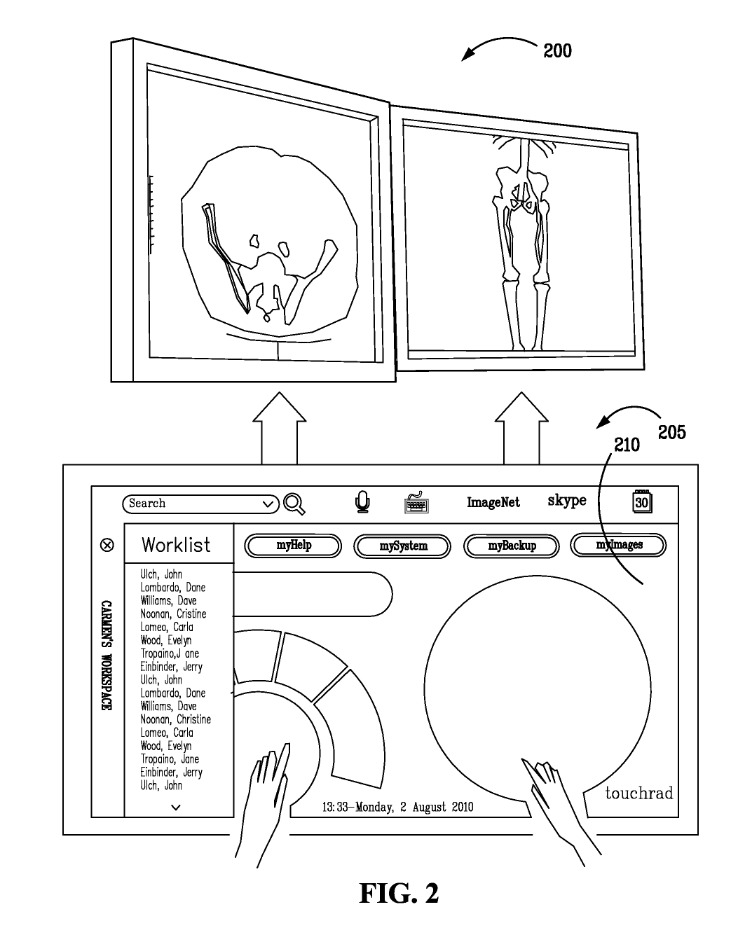

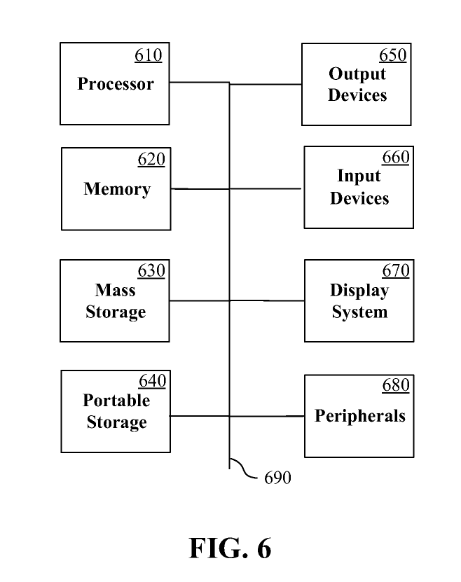

Referring now to FIGS. 1-3 collectively, an exemplary radiological workstation 110 includes a computing system, described in greater detail with reference to computing system 600 (FIG. 6) adapted for the particular purpose of analyzing radiological images and creating radiological reports indicative of the radiological images. These reports may be created automatically in some embodiments. More specifically, the workstation 110 may include two or more high-resolution monitors 200 and a multi-touch sensing device, hereinafter “device 205,” communicatively coupled with the radiological workstation 110 via a controller that may be associated with at least one of the workstation 110 and the device 205. Note that the human hands in the FIG. 2 are not necessarily drawn to scale, for clearness of illustration.

According to various embodiments, the radiological workstation 110 in combination with the device 205 may be communicatively coupled with one or more components of the architecture 100 via a secure virtual network connection (VNC). The specific details for establishing a VNC between the radiological workstation 110 in combination with the device 205 are beyond the scope of this application, but would be well known to a person of ordinary skill in the art at the time the present invention was made. Gesture control of the PACS may take place with solutions such as, for example, RealVNC, Citrix, or any other suitable solutions. These solutions provide virtual access to a desktop, applications on that desktop, and content via a secure VNC.

According to some embodiments, the device 205 may include a touch screen 210 disposed with a protective housing (not shown). The device 205 may be adapted to display one or more user interfaces generated by a user interface module, as discussed in greater detail herein. Modules or engines mentioned herein can be stored as software, firmware, hardware, as a combination, or in various other ways. It is contemplated that various modules, engines, or the like can be removed or included in other suitable locations besides those locations specifically disclosed herein. In various embodiments, additional modules or engines can be included in the exemplary system described herein.

The touch screen 210 may include any one of a number of devices, assemblies, or apparatuses capable of displaying graphical user interfaces and receiving input in the form of touch gestures including but not limited to pinching, sliding, swiping, taping, single touch, dragging, tap and drag, etc. The touch screen 210 may include any one of a number of commonly utilized touch screen technologies including, but not limited to, resistive, capacitive, strain gauge, infrared, ultrasound, dispersive signal, etc.

According to various embodiments, the device 205 may be communicatively coupled with the radiological workstation 110 via any one of a number of commonly utilized connections such as Bluetooth, Wi-Fi, serial port, universal serial bus (USB), fire wire, Ethernet, or any other known wireless or wired connections.

A device driver application 300 may reside on either the radiological workstation 110 or the controller as discussed herein, and a medical imaging application 305 may reside on the radiological workstation 110.

A controller 310 may be utilized to communicatively couple the radiological workstation 110 with the device 205 and may include any one of a number of controllers that would be known to one of ordinary skill in the art with the present disclosure before them. According to some embodiments, the controller 310 may include a memory for storing the device driver application 300, although in some alternative embodiments, the device driver application 300 may reside within the memory of the radiological workstation 110. The controller 310 may include an integrated processor adapted to execute the device driver application 300, although the processor of the radiological workstation 110 may likewise be adapted to execute the device driver application 300.

It will be understood that the controller 310 chosen may depend in part upon the particular configuration of the touch screen 210 chosen and/or the bus architecture (e.g., AT/ISA, PCI, or SCSI) of the radiological workstation 110. It will further be understood that in applications where the controller 310 may be included within the device 205, the controller 310 may include any one of a number of known micro-controllers.

The device driver application 300 may be adapted to translate touch gesture input received via the device 205 into functions of one or more medical imaging applications 305 associated with the workstation 110. T medical imaging application 305 may be adapted to allow a radiologist to analyze radiological images by executing a series of functions (e.g., view, annotate, modify, etc.). The medical imaging application 305 may include any number of functions such as: open, close, save, scroll, pan, zoom, crop, flip, invert, level, sort, rotate, change layout, center, highlight, outline, draw reference line, annotate, 3D render, measure, erase, stack, brightness, contrast, reposition, select, key mark, key save, display all key images, or combinations thereof, although one of ordinary skill in the art will appreciate that this is not an exhaustive list of functions. Moreover, for the sake of brevity, only a few of the aforementioned functions will be described in greater detail with regards to the device driver application 300. It is noteworthy that a suitable but non-limiting example of a medical imaging application 305 includes a commercially available software package produced by MERGE Healthcare Incorporated and sold under the trade name eFilm Workstation™. An eFilm Workstation™ Quick Reference guide and an eFilm User Guide (e.g., version 2.1.2) are also available from MERGE Healthcare Incorporated.

As stated previously, the device 205 may be a plug-in device adapted to communicatively couple with any one of a number of different radiological workstations 110 via the controller 310. In additional embodiments, the device 205 and controller 310 may be integrated directly into the workstation 110.

According to some embodiments, the device driver application 300 may include one or more modules or engines. It will be understood that the processor of the radiological workstation 110 may execute the constituent modules described herein. The modules of the device driver application 300 may be adapted to effectuate respective functionalities attributed thereto. According to some embodiments, the device driver application 300 may include a user interface module 315, a gesture management module 320, an application programming interface 325, and a gesture analysis module 330. It is noteworthy that the device driver application 300 may include more or fewer modules and engines (or combinations of the same) and still fall within the scope of the present technology. Additionally, the modules disclosed herein may be combined as a constituent module or engine within a medical imaging application 305 or a comprehensive picture archiving and communications system.

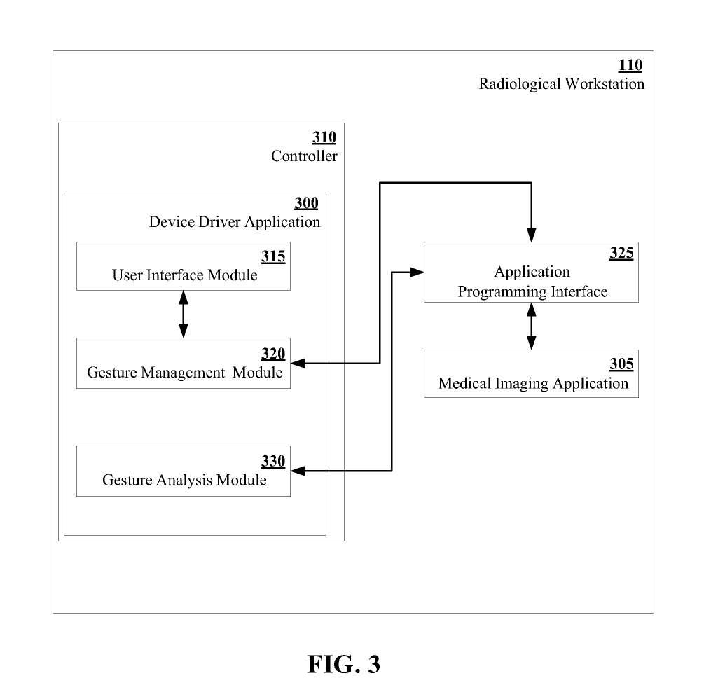

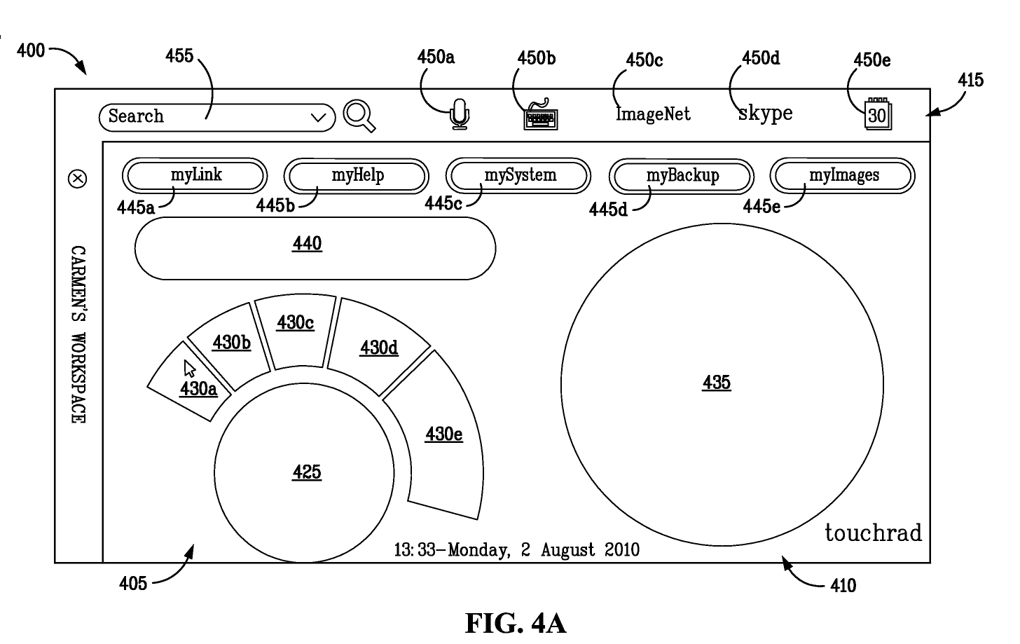

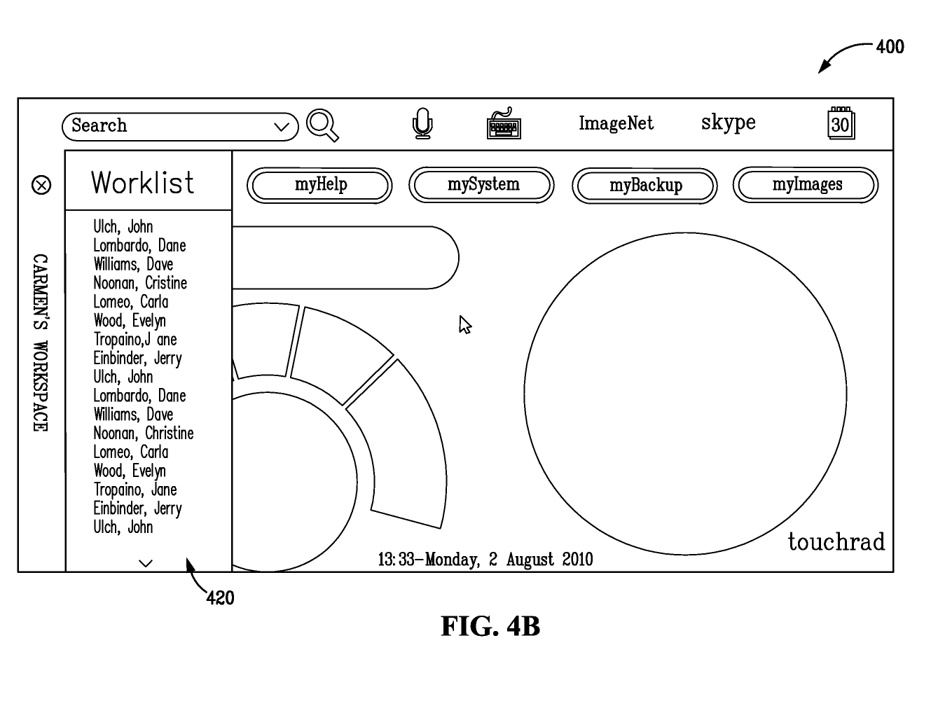

Referring now to FIGS. 3, 4A, and 4B collectively, the user interface module 315 is adapted to generate one or more user interfaces such as work area 400 (FIG. 4A) adapted to receive touch gestures that control the execution of functions of the medical imaging application 305. The work area 400 may be displayed on the touch screen 210 and may generally include a first sensing area 405, a second sensing area 410, a toolbar 415, and a work list 420 (FIG. 4B). According to some embodiments the first sensing area 405 may include a substantially circular sensing area 425 having a plurality of polygonal sensing areas 430a-e arranged in a substantially arcuate pattern around the top portion of the circular sensing area 425.

According to some embodiments, the circular sensing area 425 and plurality of polygonal sensing areas 430a-e cooperate to conform to a hand of a user such that various fingers of the user's hand may be provided with a separate polygonal sensing area. It is contemplated that in some embodiments, the user's palm may rest within the circular sensing area 425. As such, in some embodiments, the circular sensing area 425 may be adapted to selectively sense gestures from the polygonal sensing areas 430a-e. Also, according to some embodiments, some of the polygonal sensing areas such as the substantially polygonal sensing area 430e may be elongated so as to allow for swiping and pinching touch gestures in addition to taping gestures.

Additionally, the second sensing area 410 may include a substantially circular sensing area 435 adapted to receive touch gestures from a second hand of a user. Therefore, first sensing area 405 and second sensing area 410 may be configured to receive touch gestures from both hands of the user either independently or in conjunction with one another.

Although the work area 400 has been described as including the first and second sensing areas 405 and 410 that differ in configuration, it will be understood that the configurations of the first and second sensing areas 405 and 410 may be substantially identical. Moreover, in some embodiments, configurations of the first and second sensing areas 405 and 410 (or any portion(s) of the device 205) may be inverted or otherwise adjusted.

While the first and second sensing areas 405 and 410 have been disclosed has having particular geometrical configurations, one of ordinary skill in the art will appreciate that the first and second sensing areas 405 and 410 may each include any one of a number of different geometrical configurations, the shape of which may be user-defined. Moreover, the geometrical configurations of the first and second sensing areas 405 and 410 may be substantially identical to one another or substantially different. Also, the work area 400 may include additional or fewer sensing areas than the first and second sensing areas 405 and 410.

The work area 400 may also optionally include a swipe pad 440 disposed above the polygonal sensing areas 430a-e of the first sensing area 405. The swipe pad 440 may be adapted to sense swiping touch gestures that execute one or more functions of the medical imaging application 305, as will be discussed in greater detail herein.

The work area 400 may also include a plurality of user-configurable “buttons” 445a-e selectively operable via tapping gestures received from the user via the device 205 or a mouse click. In some embodiments, the term “button” as used herein does not refer to actual push-buttons such as on a keyboard. Instead, the term refers to a selectable area on a multi-touch screen. Selecting (e.g., tapping, swiping, activating, etc.) button 445a may cause the display of a list of links to objects such as a document, a URL, an IP address, etc. Selecting button 445b may cause the display of a help menu that includes a plurality of help related topics relative to, for example, functions of the medical imaging application 305, the appearance of the work area 400, a list of functions associated with gestures, etc.

Selecting button 445c may display a directory in the form a menu that provides the user with access to documents or files located on one or more storage devices of the remote archiving server 120 (FIG. 1). Selecting button 445d may provide the user with access to backups of files such as radiological reports or radiological studies previously saved either locally on the radiological workstation 110 or remotely on the remote archiving server 120 (also FIG. 1). Selecting button 445e may provide the user with access to a list of radiological images stored either locally on the radiological workstation 110 or remotely on remote archiving server 120. The radiological images listed may pertain to active but incomplete radiological studies currently being prepared by the radiologist.

According to some embodiments, the tool bar 415 may include one or more icons 450a-e that are respectively associated with an ancillary application. The tool bar 415 may be disposed within a border along a peripheral edge of the work area 400. For example, during the analysis of radiological images for a particular patient, the radiologist may select icon 450a that executes a dictation or speech-to-text application adapted to receive audio input associated with the radiological images currently being analyzed. The audio input may be associated with the radiological report and saved along with the radiological report on the remote archiving server 120. Additionally, rather than typing notation into the radiological report via a keyboard, the dictation application may also translate verbal notation into written communication that is saved in a word processing document or may be overlaid onto one or more radiological images. For example, the radiologist may desire to label an area of interest on a particular radiological image. Rather than typing the information via a keyboard onto the image, the radiologist may speak the notation into a microphone associated with the radiologist workstation 110, which is then translated by the dictation application into a textual representation that may be applied to the radiological image.

Icon 450b, when activated, may selectively display a user interface in the form of a virtual keyboard that allows the radiologist to type notation into the radiological report. Icon 450c may provide access to an image repository application that allows a radiologist to query for other radiological images or reports. The details of the image repository application will be discussed in greater detail infra. Icon 450d, when selected, may execute a peer-to-peer communications link between the radiological workstation 110 and one or more computing systems located remotely. It will be understood that the communications link may include a voice over Internet protocol (VoIP) link, or any other commonly utilized peer-to-peer communications application. Icon 450e may execute any one of a number of calendar or scheduling applications that are associated with the radiological workstation 110.

The work area 400 may also include a query box 455 adapted to allow the radiologist to perform generalized or specific searches, both locally and remotely, for any one of a number of objects such as radiological images, audio files, documents, and the like.

The work list 420 may be configured to include a queue of radiological studies arranged according to patient name for which a radiological report is required. The queue may be continuously updated to add additional radiological studies for radiological reports that are completed.

Prior to utilizing the device 205, the device driver application 300 may be configured to cooperate with the medical imaging application 305 via the gesture management module 320. As stated herein, the medical imaging application 305 may include a plurality of functions that may be utilized by the radiologist to analyze radiological images and create radiological reports indicative of the radiological images. As also stated herein, exemplary functions may include but are not limited to any of: open, close, save, scroll, pan, zoom, crop, flip, invert, level, sort, rotate, change layout, center, highlight, outline, draw reference line, annotate, 3D render, measure, erase, stack, brightness, contrast, reposition, select, key mark, key save, display all key images, etc., or combinations thereof.

The gesture management module 320 may be adapted to associate touch gestures or combinations of touch gestures with one or more of the above-described functions. For example, in some embodiments, a circular single-fingered touch gesture within the second sensing area 410 may bring up an options menu or tool bar. A single touch, right-to-left, sliding gesture within the swipe pad 440 may both window and level the radiological image in some embodiments. A single touch and hold gesture within any one of the polygonal sensing areas 430a-e may allow radiological images to be selected then rearranged or placed as different image view layouts such as a 1×1 or 4×4 radiological image set configurations. Also, a simultaneous two-touch up-and-down gesture such as a single-fingered touch within each of the first and second sensing areas 405 and 410 may scroll through a radiological image set.

In keeping with the invention, simultaneous two-touch left to right gestures within both the substantially circular sensing area 425 of the first sensing area 405 and the second sensing area 410 may pan through a plurality of radiological images within a set in some embodiments. According to some embodiments, two singular touch gestures utilizing different hands may execute a rectangular window area selection that may or may not be zoomed. In some embodiments, two double touch gestures with different hands may allow a free form window area selection that may or may not be zoomed. It will be understood that these zoomed radiological images may then be simultaneously or successively panned, zoomed, sorted, rotated, window leveled or otherwise manipulated via subsequent gestures. As such, the device driver application 300 may be adapted to process synchronous or at least partially overlapping touch gestures receive by both the first and second sensing areas 405 and 410 of the device 205.

The gesture management module 320 may be adapted to generate a list of available functions of the medical imaging application 305 and allow the radiologist to select which gesture or gestures the radiologist would like to associate with a particular function.

The application programming interface 325 may be adapted to translate the gestures defined by the radiologist, via the gesture management module 315, to pertinent functions of the medical imaging application 305. Generally speaking, an application programming interface allows applications residing on different platforms or written in different coding languages to interoperate. As such, the particularities of the application programming interface 325 utilized herein may be dependent, in part, upon the particular language or languages in which the device driver application 300 and the medical imaging application 305 are coded. For the sake of brevity, as the device driver application 300 and the medical imaging application 305 are not limited to any particular coding language, a detailed discussion of the use of application programming interfaces will not be provided as the creation and use of application programming interfaces would be well known to one of ordinary skill in the art with the present disclosure before them.

Once touch gestures are received via the touch screen 210 of the device 205, the touch gestures may be evaluated by the gesture analysis module 330. The gesture analysis module 330 may determine if the touch gestures received are associated with one or more functions of the medical imaging application 305. If the gesture analysis module 330 determines that one or more functions are associated with the touch gesture, the gesture analysis module 330 may communicate with the medical imaging application 305 via the application programming interface 330 to cause the medical imaging application 305 to execute the functionality attributed to the touch gesture or gestures received.

Returning briefly to the ancillary application (that may be activated by tapping icon 450c), which was described generally as an image repository application, the image repository may be broadly described as database residing on a server or plurality of servers such as the remote archiving server 120 that may be adapted to receive and retain radiological images for subsequent use. One example is ImageNet—a sharing and storage solution with a social networking component. ImageNet is a repository for images. For example, radiological images captured by one or more image capturing devices 105 (FIG. 1) may be adapted to associate only a limited amount of a patient's personally identifiable information with the radiological images obtained. It will be understood that in some embodiments, none of the patient's personally identifiable information is associated with the radiological images. These radiological images may be stored on the remote archiving server 120 and accessed by any of one of a physician workstation 125, a radiological workstation 110, or any other authorized computing system. Subsequent uses include utilizing the radiological images stored on the remote archiving server 120 may serve as a training aid. For example, a physician or radiologist instructing students in the analysis of radiological images may utilize radiological images resident on the remote archiving server 120.

In some alternative applications, if a physician or radiologist locates an anomaly on a radiological image that is of unknown origin or difficult to diagnose, the radiologist or physician may search the remote archiving server 120 for radiological reports that are similar to the radiological image having the anomaly, such as location within the body, size, surrounding features, and the like. If the radiologist locates similar radiological images having similar anomalies and the similar radiological images are associated with a previously successful diagnosis, the radiologist may consider the same diagnosis for the subject radiological image and annotate the same in the radiological report. It will be understood that information contained within a radiological report may include radiologist or physician contact information, patient date of birth, age, sex, social security number, etc.

It is noteworthy that embodiments of the present system may act as platforms for other radiology related productivity tools and applications such as voice recognition and speech-to-text systems (e.g., Dragon software), collaboration software (e.g., Skype), 3D image reconstruction (e.g., TeraRecon), MIP/MPR (e.g., NovaRad), other related PACS or RIS enhancements, etc. These programs and others may be accessed by tapping icons (similar to hotkeys, but in some embodiments not actually keys that are depressed). ImageNet may be accessed in a similar fashion.

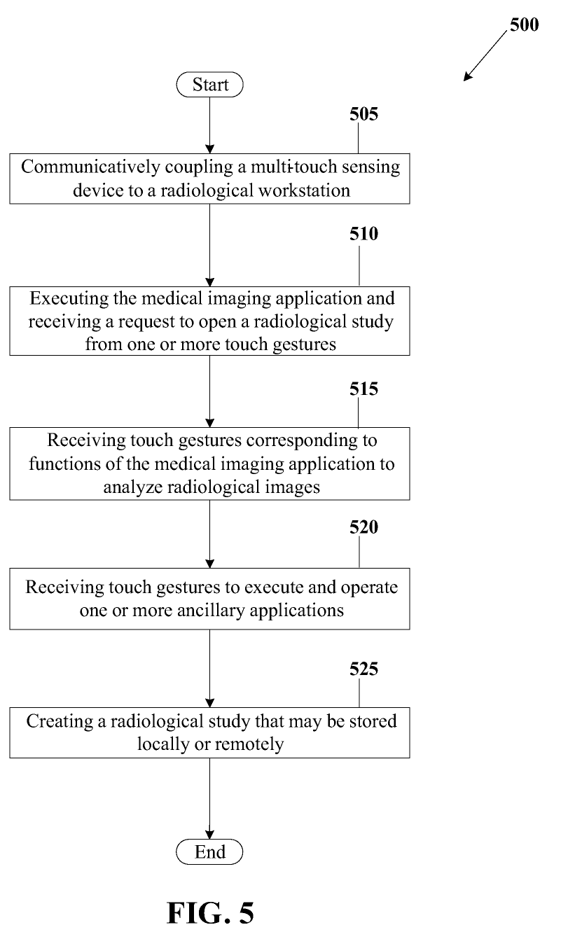

Referring now to FIG. 5, a method 500 for controlling a medical imaging application executable on a radiological workstation may include a step 505 of communicatively coupling a multi-touch sensing device with a radiological workstation. It will be understood that in some embodiments where the multi-touch sensing device is an integral part of the radiological workstation, step 505 may not be necessary.

Next, the medical imaging application is executed on the radiological workstation and the multi-touch sensing device may receive a request to open a radiological study via touch gestures received from the radiologist in step 510. The touch gestures may be received within any one of the sensing areas of the work area displayed on the multi-touch sensing device. For example, a circular single-fingered touch gesture within the second sensing area may bring up an options menu or tool bar that includes options of such as: open, save, save as, close, and the like. It will be understood that the radiologist may select one of the options by tapping the open option listed on the options menu and selecting the desired radiological study. Also, a radiological study may be opened by receiving a selection corresponding to the name of a patient listed in the work list.

Once opened, appropriate touch gestures may be received from the multi-touch sensing device in step 515 that are indicative of an analysis of radiological images by the radiologist. The touch gestures may be received within any of the sensing areas of the work area. It will be understood that the received touch gestures execute functions of the medical imaging application as previously described.

During step 515 of analysis, the multi-touch sensing device may receive touch gestures for executing and operating one or more ancillary applications in step 520, in furtherance of the creation of a radiological report indicative of the radiological images under analysis.

In step 525, a radiological report may be created from the analyzed radiological images by receiving a digital signature corresponding to the radiologist. The signed radiological report may be stored locally on the radiological workstation or remotely on the remote archiving server. According to some implementations, the radiological reports may be directly communicated to a physician workstation located remotely from the radiological workstation.

It is contemplated that any suitable features may be initiated and/or controlled via various gestures or other user input. Some examples include but are not limited to invoking: a daily schedule and network, diagnosis request, image scan, viewing and analyzing case images, marking abnormal volumes, speech-to-text reporting, automated online searching for similar cases, opening an online reference case, calling the physician from a reference case for an audio and/or video conference, reviewing reports, etc.

FIG. 6 illustrates an exemplary computing system 600 that may be used to implement an embodiment of the present invention. System 600 of FIG. 6 may be implemented in the context of radiological workstations 110, the device 205, and the like. The computing system 600 of FIG. 6 includes one or more processors 610 and memory 620. Main memory 620 stores, in part, instructions and data for execution by processor 610. Main memory 620 can store the executable code when the system 600 is in operation. The system 600 of FIG. 6 may further include a mass storage device 630, portable storage medium drive(s) 640, output devices 650, user input devices 660, a graphics display 640, and other peripheral devices 680.

The components shown in FIG. 6 are depicted as being communicatively coupled via a single bus 690. The components may be communicatively coupled through one or more data transport means. Processor unit 610 and main memory 620 may be communicatively coupled via a local microprocessor bus, and the mass storage device 630, peripheral device(s) 680, portable storage device 640, and display system 670 may be communicatively coupled via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 610.

Portable storage device 640 operates in conjunction with a portable non-volatile storage medium, such as a floppy disk, compact disk or Digital video disc, to input and output data and code to and from the computing system 600 of FIG. 6. The system software for implementing embodiments of the present invention may be stored on such a portable medium and input to the computing system 600 via the portable storage device 640.

Input devices 660 provide a portion of a user interface. Input devices 660 may include an alphanumeric keypad, such as a keyboard, for inputting alphanumeric and other information, or a pointing device, such as a mouse, a trackball, stylus, or cursor direction keys. Additionally, the system 600 as shown in FIG. 6 includes output devices 650. Suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computing system. Peripheral device(s) 680 may include a modem or a router.

The components contained in the computing system 600 of FIG. 6 are those typically found in computing systems that may be suitable for use with embodiments of the present invention and are intended to represent a broad category of such computer components that are well known in the art. Thus, the computing system 600 of FIG. 6 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “non-transitory computer-readable storage medium” and “non-transitory computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a flash EEPROM, a non-flash EEPROM, any other memory chip or cartridge, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

While the present invention has been described in connection with a series of preferred embodiment, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

What is claimed is:

1. A multi-touch sensing device for use with a radiological workstation capable of displaying radiological images, the device comprising:
a touch screen communicatively coupled with the radiological workstation via a controller, the touch screen adapted to display a work area that includes at least one of:
a first sensing area adapted to receive touch gestures from a first hand of a user; and
a second sensing area adapted to receive touch gestures from a second hand of the user; and
wherein touch gestures received from the user via the multi-touch sensing device execute functions controlling a medical imaging application executable on the radiological workstation, the medical imaging application adapted to allow a user to analyze radiological images displayed by the radiological workstation.

2. The device of claim 1, wherein the first sensing area includes a circular area and a plurality of substantially polygonal areas arranged in an arcuate pattern around an upper portion of the circular area, the plurality of substantially polygonal areas each corresponding to a particular finger of at least one of the first hand and the second hand of the user.

3. The device of claim 2, wherein the second sensing area includes a circular area having an outer peripheral geometry larger than the circular area of the first sensing area.

4. The device of claim 1, wherein touch gestures execute functions controlling the medical imaging application via one or more application programming interfaces.

5. The device of claim 4, wherein functions include any of open, close, save, scroll, pan, zoom, crop, flip, invert, level, sort, rotate, change layout, center, highlight, outline, draw reference line, annotate, 3D render, measure, erase, stack, brightness, contrast, reposition, select, key mark, key save, display all key images, and combinations thereof.

6. The device of claim 5, wherein the multi-touch sensing device is adapted to receive touch gestures from both first and second sensing areas simultaneously to execute two or more functions controlling the medical imaging application at substantially the same time.

7. The device of claim 1, wherein the work area further includes a swipe pad adapted to receive swiping touch gestures from a user.

8. The device of claim 1, wherein the work area includes a tool bar disposed within a border along a peripheral edge of the work area, the tool bar including at least one icon operatively associated with an ancillary application.

9. The device of claim 8, wherein the ancillary application includes any of: a virtual keyboard that is overlaid onto the work area, a voice over Internet protocol communication application, an image repository application, an audio recorder application, a dictation application, a calendar application, and combinations thereof.

10. The device of claim 1, wherein the radiological workstation is communicatively coupled via a virtual network control protocol with at least one of a second radiological workstation, an image capturing device, a remote archiving server, and a physician workstation.

11. A radiological workstation capable of displaying radiological images, the workstation comprising:
a memory for storing a device driver application and a medical imaging application;
a processor for executing the device driver application and the medical imaging application; and
a controller communicatively coupled with the radiological workstation and a multi-touch sensing device that includes:
a touch screen adapted to display a work area that includes at least one of:
a first sensing area adapted to receive touch gestures from a first hand of a user; and
a second sensing area adapted to receive touch gestures from a second hand of the user; and
wherein touch gestures received from the user via the multi-touch sensing device are translated into functions controlling the medical imaging application via one or more application programming interfaces, the medical imaging application adapted to allow a user to at least one of analyze radiological images displayed by the radiological workstation and create a radiological report indicative of the radiological images.

12. A method for controlling a medical imaging application executable on a radiological workstation, the medical imaging application having a plurality of functions that allow a user to analyze radiological images, the method comprising:
executing the medical imaging application;
receiving a request to display at least one radiological image, the request including touch gestures received from a multi-touch sensing device, the multi-touch sensing device including:
a touch screen communicatively coupled with the radiological workstation via a controller, the touch screen adapted to display a work area that includes at least one of:
a first sensing area adapted to receive touch gestures from a first hand of a user; and
a second sensing area adapted to receive touch gestures from a second hand of the user; and
wherein touch gestures received from the user via the multi-touch sensing device execute functions controlling the medical imaging application; and
displaying at least one radiological image via a radiological workstation in response to a received touch gesture.

13. The method of claim 12, wherein prior to displaying at least one radiological image, the method includes displaying a radiological study that includes at least one radiological image and receiving touch gestures indicative of a selection of one or more radiological images from the radiological study.

14. The method of claim 12, further comprising updating the at least one radiological image based upon gestures received via the multi-touch sensing device in response to displaying the at least one radiological image.

15. The method of claim 12, further comprising receiving audio notation corresponding to the at least one radiological image and associating the audio notation with the at least one radiological image in response to receiving one or more touch gestures via the multi-touch sensing device.

16. The method of claim 12, wherein functions controlling the medical imaging application include any of: open, close, save, scroll, pan, zoom, crop, flip, invert, level, sort, rotate, change layout, center, highlight, outline, draw reference line, annotate, 3D render, measure, erase, stack, brightness, contrast, reposition, select, key mark, key save, display all key images, and combinations thereof.

17. The method of claim 12, wherein the gestures include any of: pinch, swipe, slide, tap, and combinations thereof.

18. The method of claim 12, further comprising receiving at least one of synchronous or at least partially overlapping touch gestures via both the first and second sensing areas of the multi-touch sensing device to execute two or more functions controlling the radiological workstation.

19. The method of claim 12, further comprising creating a radiological report by storing analyzed radiological images as a record adapted to reside in a database communicatively coupled with the radiological workstation.

20. The method of claim 19, wherein creating a radiological report further includes:
executing a dictation application in response to receiving a touch gesture via the multi-touch sensing device;
receiving a dictated message corresponding to the at least one radiological image via the dictation application; and
associating the dictated message with the at least one radiological image.

21. The method according to claim 19, wherein creating a radiological report further includes receiving input indicative of an electronic signature corresponding to a particular user.

22. The method of claim 21, further comprising establishing a peer-to-peer telecommunications link between the radiological workstation and a computing system via a touch gesture received from the multi-touch sensing device.
